(19) United States
(12) Patent Application Publication
(10) Pub. No.: US 2026/0204120 A1
(43) Pub. Date: Jul. 16, 2026

(54) ARTICLE SUPPLY DEVICE

(71) Applicant: BANDAI CO., LTD., Tokyo (JP)

(72) Inventors: Hajime KONDO, Tokyo (JP); Tatsushi IKARASHI, Tokyo (JP); Yoshiaki TATSUKI, Tokyo (JP); Nobuo KUROKAWA, Tokyo (JP)

(21) Appl. No.: 19/562,738

(22) Filed: Mar. 10, 2026

Related U.S. Application Data
(63) Continuation of application No. PCT/JP2024/041809, filed on Nov. 26, 2024.

(30) Foreign Application Priority Data
Nov. 30, 2023 (JP) 2023-203080

(51) Int. Cl. G07D 5/08; G07D 11/14; G07D 9/00

(52) U.S. Cl. CPC G07D 5/08; G07D 11/14; G07D 9/002

(57) ABSTRACT

An article supply device 1 includes: an insertion portion 5 into which a genuine coin and a counterfeit coin are able to inserted; a passage portion 20a through which a coin inserted from the insertion portion 5 is movable, and an attraction portion 23 which is incapable of attracting the genuine coin and capable of attracting the counterfeit coin in the passage portion 20a, and the attraction portion 23 is provided as a component of the passage portion 20a. In the passage portion 20a through which an inserted coin passes, the attraction portion 23 capable of attracting only the counterfeit coin is provided as a component of the passage portion 20a, that is, a part of a side wall portion of the passage portion 20a to be a flat surface having no unevenness or the like on the side wall portion.

The contents of the following patent application(s) are incorporated herein by reference:

NO. 2023-203080 filed in JP on November 30, 2023, and

NO. PCT/JP2024/041809 filed in WO on November 26, 2024.

### BACKGROUND

### 1. TECHNICAL FIELD

The present invention relates to an article supply device.

### 2. RELATED ART

Conventionally, there are various article supply devices (vending machines) for automatically selling a product. The article supply device is provided with various functions for determining a consideration necessary for purchasing a product. For example, in Patent Document 1, a coin holding portion is configured such that coins held in the coin holding portion in a row are electrically connected in series. In addition, a first electrode in contact with a coin located on one end side of the row is provided in the coin holding portion, and a second electrode in contact with a coin located on another end side of the row is provided in the coin holding portion. A configuration is disclosed in which whether or not insertion of a necessary number of coins is completed is determined based on whether a current flows between the first electrode and the second electrode.

### RELATED ART DOCUMENTS

### PATENT DOCUMENT

Patent Document 1: Japanese Patent Application Publication No. 2005-196318

### BRIEF DESCRIPTION OF THE DRAWINGS

FIG. 1 is a perspective view illustrating an appearance of an article supply device according to an aspect of the present invention.

FIG. 2 is a schematic cross-sectional view illustrating an internal structure of the article supply device illustrated in FIG. 1.

FIG. 3 is a perspective view of a coin insertion unit illustrated in FIG. 2.

FIG. 4 is an enlarged perspective view of an attraction portion illustrated in FIG. 3.

FIG. 5 is a cross-sectional view of a part taken along line A-A illustrated in FIG. 3.

FIG. 6 is an enlarged perspective view illustrating another aspect of the attraction portion.

### DESCRIPTION OF EXEMPLARY EMBODIMENTS

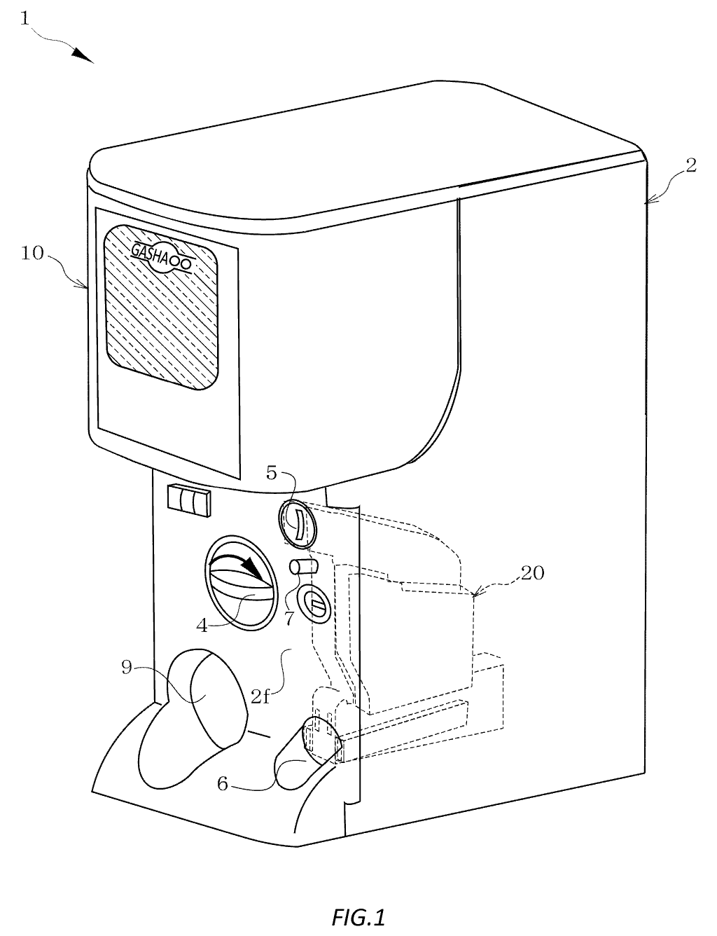

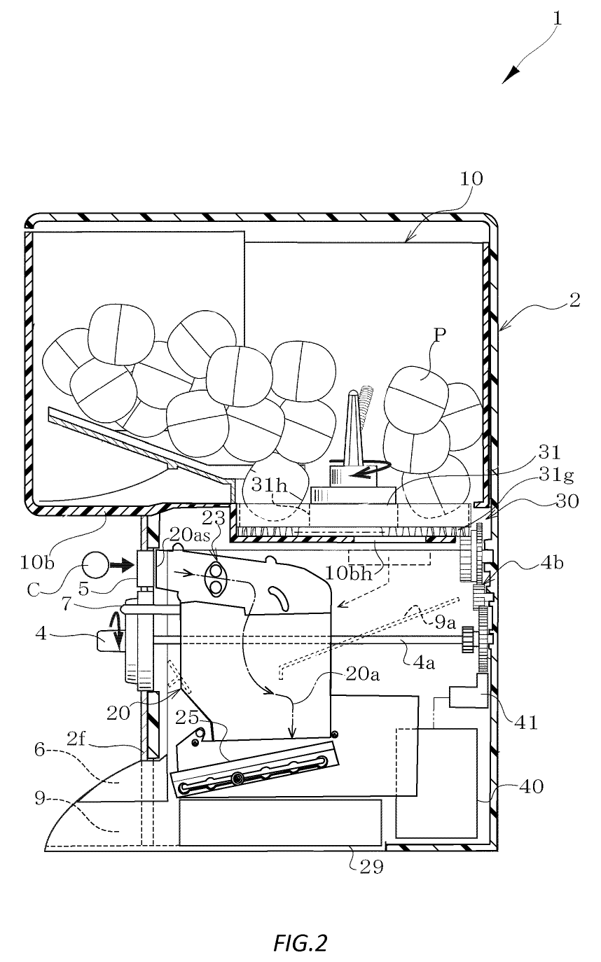

Hereinafter, an article supply device according to an aspect of the present invention will be described with reference to the drawings. FIG. 1 is a perspective view illustrating an appearance of an article supply device 1 of the present aspect, and FIG. 2 is a schematic cross-sectional view illustrating an internal structure of the article supply device 1.

The article supply device 1 illustrated in FIGS. 1 and 2 is a device capable of supplying an article P which is a spherical capsule case in which a toy or a component is accommodated, for example. To explain in more detail, the article supply device 1 includes an accommodation portion 10 which is capable of accommodating a plurality of articles P in random arrangement, a supply portion 30 which is rotatably provided on a bottom portion 10b of the accommodation portion 10 and has a rotary disk 31 that can randomly select and supply the articles P one by one, and a lock portion 41 which locks the supply portion 30 to be inoperable, and a control portion 40 drives the lock portion 41 to release the lock on condition that payment for a consideration is made through an insertion portion 5 for the coin C. Then, in an unlocked state, an operation portion 4 provided on a front surface 2f is rotated. Accordingly, a gear train 4b provided on a distal end side of a shaft 4a of the operation portion 4 rotates, and the rotary disk 31 is rotated via a rack gear 31g. The article P held in a holding hole 31h of the rotary disk 31 drops at a through-hole 10bh provided at the bottom portion 10b, and is supplied to a supply port 9 via an article passage portion 9a.

In the article supply device 1, a coin insertion unit 20 is provided on a right side (a right side when facing the device) of the operation portion 4. The coin insertion unit 20 is connected to the insertion portion 5 provided on the front surface 2f of a main body 2. Then, the coin C inserted through the insertion portion 5 passes through a passage portion 20a formed in the coin insertion unit 20 and drop to be held in a holding portion 25 on a lower side of the unit. In addition, when a genuine coin is inserted, the coin C held by the holding portion 25 is accommodated in a coin accommodation portion 29 provided, for example, below the holding portion 25 when a predetermined amount is inserted and a predetermined operation is performed. However, a counterfeit coin as a second-type coin, rather than a genuine coin as a first-type coin, may be inserted as the coin C to be inserted. In this case, an attraction portion 23 provided in the passage portion 20a is configured to be able to capture the counterfeit coin as described later.

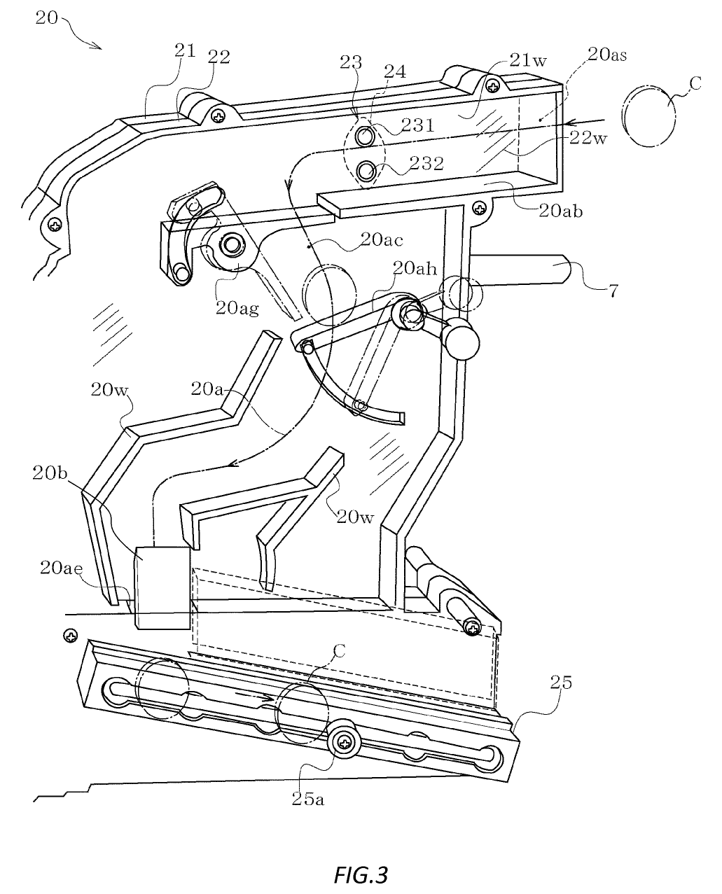

FIG. 3 is a perspective view of a main part of the coin insertion unit 20 illustrated in FIG. 2. As illustrated in FIG. 2, the coin insertion unit 20 is a thin unit in which a left half case 21 and a right half case 22 are combined from a left and right direction, and a first side wall portion 21w and a second side wall portion 22w, which are their left and right side walls, approach and face each other to form an internal space. Here, the left half case 21 including the first side wall portion 21w is made of a colored material and formed to be opaque, whereas the right half case 22 including the second side wall portion 22w is made of a material having a color different from that of the left half case 21, for example, a light-transmissive material. Therefore, an inside of the unit can be seen through the second side wall portion 22w as illustrated in FIG. 3.

In the coin insertion unit 20, the passage portion 20a is formed from a start end portion 20as (an upper right side in the figure) into which the coin C is inserted to a terminal end portion 20ae of an inlet of the holding portion 25 that holds the coin C. The passage portion 20a is configured such that the coin C moves by gravity. For example, a first coin introduction part including the start end portion 20as is provided with an inclined portion 20ab constituting an inclined surface on which the coin C rolls. A drop portion 20ac is provided on a rear side of the inclined portion 20ab, and the coin C drops from the inclined portion 20ab. The dropped coin C is guided by a passage wall 20w and drops again, passes through an opening which is the terminal end portion 20ae of the passage portion 20a, and drops to the holding portion 25.

Note that in a drop portion 23ac, a first swing plate 20ag is provided on an upper side, and a second swing plate 20ah is provided on a lower side. These swing plates 20ag and 20ah rotate by a weight of the coin C when the coin C is placed on the swing plates, thereby guiding the coin C in an inclination direction of the plate portion. This, for example, makes it possible to change a moving direction of the coin C and reduce a dropping speed of the coin C.

The coin C having dropped on the holding portion 25 is held by the holding portion 25 capable of holding a genuine coin. The holding portion 25 has an inclination that allows the genuine coin having dropped into the holding portion 25 to move toward a front surface 2f (see FIG. 2) by its own weight. In addition, a moving position of the coin C at this time is regulated by a position regulating pin 25a, and a prescribed number of coins C can be held.

A coin sorting member 20b which sorts the coins C to both left and right sides is provided in the opening of the terminal end portion 20ae. Although not illustrated in FIG. 3, a holding portion having a same configuration as that of the holding portion 25 is also provided on the first side wall portion 21w side, and the coin C can be sorted to the left or right by the coin sorting member 20b.

In addition, a return button 7 is provided below the insertion portion 5. For example, when a user wishes to return the already inserted coin C, the return button 7 can discharge the coin C held in the holding portion 25 to a return port 6 by performing a pressing operation.

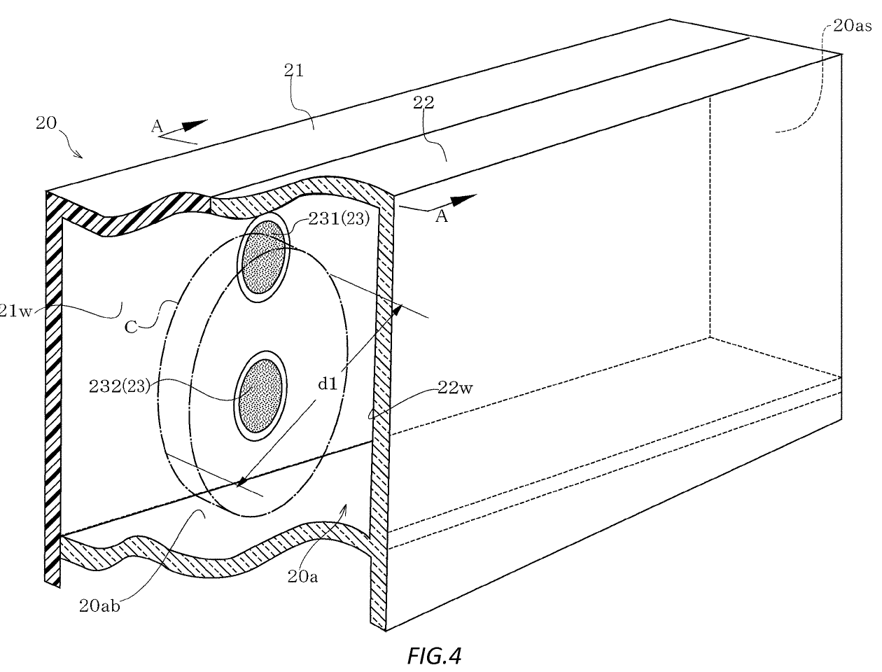

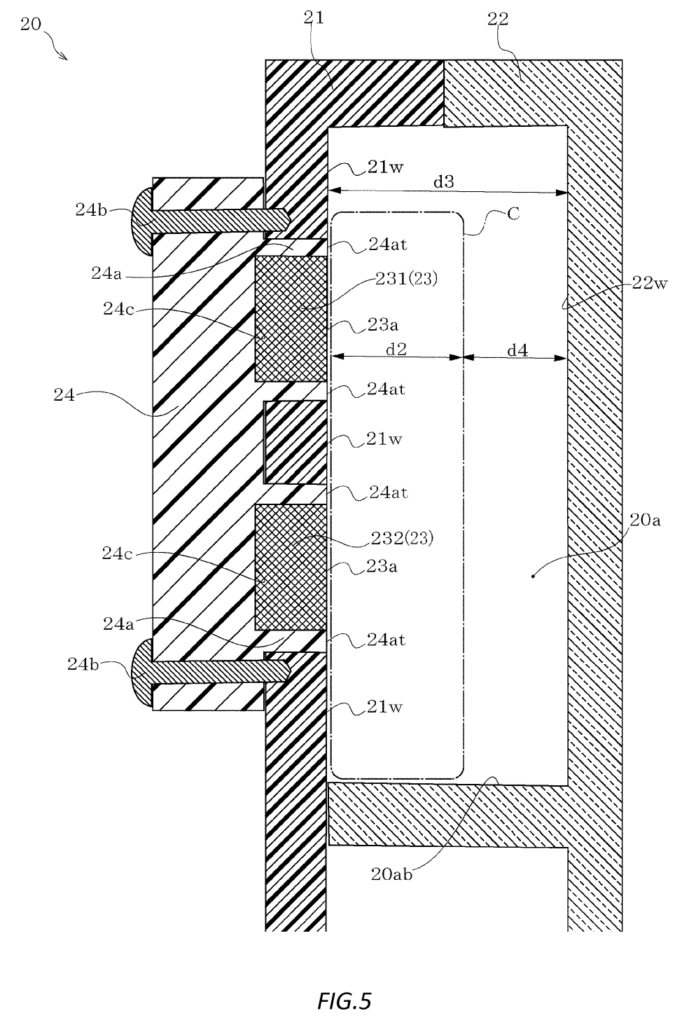

FIG. 4 is an enlarged perspective view of the attraction portion 23 illustrated in FIG. 3, and FIG. 5 is a cross-sectional view of a part taken along line A-A of FIG. 4. As illustrated in the figure, the attraction portion 23 which captures a counterfeit coin is provided in a region where the inclined portion 20ab is disposed, that is, at a position close to the start end portion 20as. In the inclined portion 20ab, a moving speed of the inserted coin C is not so fast, and the counterfeit coin is attracted by the attraction portion 23 before the drop portion 20ac (the moving speed becomes fast), whereby the counterfeit coin is prevented from dropping into the drop portion 20ac.

In addition, the attraction portion 23 is disposed as a part of a side wall portion which is a component of the passage portion 20a. The attraction portion 23 is composed of, for example, a pair of magnets, a first attraction portion 231, and further, a second attraction portion 232, and the first attraction portion 231 and the second attraction portion 232 are provided at an appropriate gap in accordance with a size (d1) of the coin C. In this manner, a magnetic force of the attraction portion 23 is increased by being arranged vertically and provided to be spaced apart by a predetermined distance. That is, the first attraction portion 231 and the second attraction portion 232 are disposed at a distance in a range that they affect each other's magnetic fields. In addition, a configuration in which the first attraction portion 231 and the second attraction portion 232 are vertically arranged is capable of coping with large and small counterfeit coins.

In addition, the attraction portion 23 is provided on the first side wall portion 21w via an attachment portion 24. The attachment portion 24 holds, for example, the first attraction portion 231 and the second attraction portion 232 in recesses 24c of cylindrical portions 24a on one end side thereof. In addition, the attachment portion 24 is fixed from an outside of the first side wall portion 21w by, for example, screws 24b or the like. A pair of circular openings are formed in the first side wall portion 21w, and the attachment portion 24 is attached such that the cylindrical portions 24a are fitted into the openings.

An attraction surface 23a of the attraction portion 23 and a distal end surface 24at of the cylindrical portion 24a are flush with the first side wall portion 21w. That is, since the attraction surface 23a is flush with the first side wall portion 21w constituting a plane of the passage portion 20a, it is possible to apply an effective magnetic force to (attract) a counterfeit coin. Note that the distal end surface 24at of the cylindrical portion 24a may be slightly recessed with respect to the first side wall portion 21w.

The passage portion 20a is configured to prevent a genuine coin from moving beyond the attraction portion 23 when a counterfeit coin is attracted to the attraction portion 23. A width (d3) of the passage portion 20a is set such that, when the counterfeit coin is attracted to the attraction portion 23, a width (d4) obtained by subtracting a thickness (d2) of the attracted coin C is smaller than a width of the genuine coin. This can be achieved, for example, by setting the width (d3) of the passage portion 20a to be close to a coin width of the genuine coin C.

In addition, in the passage portion 20a, the counterfeit coin attracted by the attraction portion 23 can be taken out by taking out the coin insertion unit 20 from the main body 2. At this time, since the attraction portion 23 is at a position close to the start end portion 20as of the passage portion 20a, the counterfeit coin attracted from the start end portion 20as side can be easily taken out.

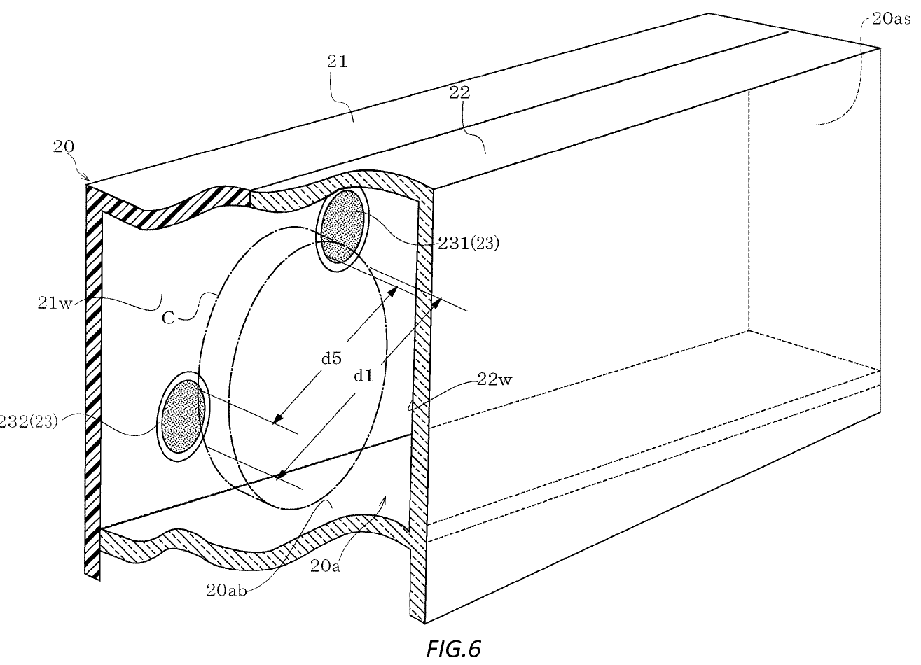

FIG. 6 is an enlarged perspective view illustrating another aspect of the attraction portion 23. In the attraction portion 23 illustrated in FIG. 6, the first attraction portion 231 and the second attraction portion 232 are provided at positions in a coin moving direction that are offset in a front-rear direction and an up-down direction. Here, in particular, a distance between both the attraction portions 231 and 232 in the moving direction of the coin C is configured to be large. Then, a distance (d5) between both the attraction portions 231 and 232 is set to be a distance less than a maximum diameter of the genuine coin C or the counterfeit coin. Accordingly, a magnetic force can be applied to the counterfeit coin in a region long in the coin moving direction, and a closed loop of the magnetic field can be formed by a magnetic force line between the attraction portions 231 and 232, and capturing can be more reliably performed.

As described above, in the article supply device 1 of the present aspect, a genuine coin is not affected by the magnetic force in the passage portion 20a through which the inserted coin passes, so that the genuine coin is not attracted, and only a counterfeit coin, which uses a magnetic body in many cases, can be attracted. In addition, the attraction portion 23 is provided as a component of the passage portion 20a, for example, as a part of a side wall portion of the passage portion 20a so as to constitute a flat surface on the side wall portion, so that it is possible to provide a coin insertion mechanism that exhibits a stable function without hindering passage of the genuine coin. Therefore, according to the present embodiment, it is possible to provide the article supply device that implements a preventive measure against use of a counterfeit coin.

In addition, in the article supply device 1 of the present aspect, it is configured to prevent a genuine coin from moving beyond the attraction portion 23 when a counterfeit coin is attracted to the attraction portion 23, so that sale of a product can be suspended.

In addition, in the article supply device 1 of the present aspect, a position where a counterfeit coin is captured by the attraction portion 23 is set to be a position close to the coin insertion portion 5, so that a counterfeit coin can be easily taken out from the insertion portion 5 side, and it is not necessary to separately provide a configuration of a takeout port.

In addition, in the article supply device 1 of the present aspect, the passage portion 20a has a structure in which two side wall portions face each other, and the attraction portion 23 is disposed on one side (first side wall portion 21w), so that a planar part of the coin C can face the surface of the attraction portion 23. Accordingly, it is possible to increase a capturing force (magnetic force) of the attraction portion 23 with respect to a counterfeit coin, enabling a reliable measure against the counterfeit coin.

In the article supply device 1 of the present aspect, the first side wall portion 21w provided with the attraction portion 23 in the side wall portion of the passage portion 20a is configured to have a color different from that of the second side wall portion 22w, so that, when a counterfeit coin is taken out or in other maintenance work, a position of the attraction portion 23 is easily recognized, resulting in excellent workability. In addition, the second side wall portion 22w is made of a light-transmissive material, so that the passage portion 20a can be visually recognized from an outside, and a maintainability of the coin insertion unit 20 can be improved.

In the article supply device 1 of the present aspect, the passage portion 20a includes the drop portion 20ac that allows a coin to drop, so that coin movement can be made fast. In addition, it is possible to allow a drop sound to occur at the time of inserting the coin and make a purchaser recognize that an insertion operation is successfully performed. In addition, when a counterfeit coin is inserted, the counterfeit coin is captured by an inclined portion 23ab in front of the drop portion 20ac and does not drop, and it is possible to eliminate occurrence of the drop sound. As a result, it is possible to inform a person which has inserted the counterfeit coin that the insertion has failed. In addition, the attraction portion 23 is provided in the inclined portion 23ab, so that a moving speed that facilitates the capture of the counterfeit coin can be set by using an inclination angle.

In addition, in the article supply device 1 of the present aspect, a plurality of attraction portions 23 made of magnets are provided, so that a closed loop of a magnetic field can be formed between the magnets, a magnetic flux density can be increased, and a counterfeit coin can be more reliably captured. In addition, when the plurality of attraction portions 23 are disposed with a distance large in the coin moving direction, if the closed loop of the magnetic field is not formed, it is possible to apply a magnetic capturing force to the counterfeit coin a plurality of times. Accordingly, for example, the moving speed is reduced in the first attraction portion, and then the counterfeit coin is easily captured in the next attraction portion, so that the counterfeit coin can be reliably captured. In addition, the plurality of attraction portions 23 are separated in a vertical direction with respect to the coin moving direction, so that it is possible to easily cope with counterfeit coins having different sizes, and it is possible to further improve reliability as a measure against counterfeit coins.

In addition, a distance between a plurality of attraction portions 23 is set to be, for example, less than a maximum diameter of a genuine coin in the coin moving direction, so that a state in which a magnetic force line passes through a counterfeit coin between the front and rear attraction portions 23 can be formed with respect to the counterfeit coin, and a strong capturing force can be applied over a maximum possible long region in the coin moving direction. Accordingly, the capturing force of the counterfeit coin is strengthened, and a more reliable measures against the counterfeit coin can be taken.

In the article supply device 1 of the present aspect, the holding portion 25 has an inclination that allows a genuine coin to move by its own weight, so that a plurality of genuine coins can be arranged without gaps and held in the holding portion 25, and it is easy to hold and confirm (detect) a coin(s) corresponding to a number of at least one coin required as payment for a product.

In the article supply device 1 of the present aspect, the coin insertion unit 20 is formed in a configuration including at least the passage portion 20a and the holding portion 25, so that it is possible to easily detach and attach the coin insertion unit 20 as a unit from the main body 2 of the article supply device 1, resulting in excellent maintainability.

Although the aspects of the present invention have been described above, the present invention can be appropriately modified within the scope of the technical idea. For example, in the above aspects, a configuration has been described in which the coin insertion unit 20 is provided in the article supply device 1 that sells the article P of a capsule case, but the device provided with the coin insertion unit 20 is not limited thereto, and can be applied to various devices for selling articles.

In addition, in the above aspects, in the configuration of the attraction portion 23, two magnets are arranged, but the present invention is not limited thereto, and one magnet or three or more magnets may be arranged.

### EXPLANATION OF REFERENCES

1: article supply device;

5: insertion portion;

6: return port;

20: coin insertion unit;

20a: coin passage portion;

20ab: inclined portion;

20ac: drop portion;

20as: start end portion;

20ae: terminal end portion;

21w: first side wall portion;

22w: second side wall portion;

23: attraction portion;

23a: attraction surface;

24: attachment portion;

25: holding portion;

231: first attraction portion;

232: second attraction portion; and

C: coin.

What is claimed is:

1. An article supply device comprising:
an insertion portion into which a first-type coin and a second-type coin are able to be inserted;
a passage portion through which a coin inserted from the insertion portion is movable; and
an attraction portion which is incapable of attracting the first-type coin and capable of attracting the second-type coin in the passage portion, wherein
the attraction portion is provided as a component of the passage portion.

2. The article supply device according to claim 1, wherein
the attraction portion is configured as a part of a side wall portion of the passage portion.

3. The article supply device according to claim 2, wherein
an attraction surface of the attraction portion is flush with a wall surface of the side wall portion.

4. The article supply device according to claim 3, wherein
the attraction portion is provided so as not to protrude into the passage portion.

5. The article supply device according to claim 4, wherein
the passage portion is configured to prevent the first-type coin from moving beyond the attraction portion when the second-type coin is attracted to the attraction portion.

6. The article supply device according to claim 5, wherein
the passage portion is configured to be capable of discharging, from the insertion portion, the second-type coin attracted to the attraction portion.

7. The article supply device according to claim 6, wherein
the attraction portion is configured as a part of a side wall portion of the passage portion,
the article supply device further comprises an attachment portion for attaching the attraction portion to the side wall portion, and
the attachment portion is configured as a part of the side wall portion together with the attraction portion.

8. The article supply device according to claim 7, wherein
the attraction portion is configured as the part of the side wall portion of the passage portion,
the side wall portion includes a first side wall portion and a second side wall portion, and
the attraction portion constitutes a part of the first side wall portion.

9. The article supply device according to claim 8, wherein
the first side wall portion is configured to have a color, and the second side wall portion is configured to have a color different from that of the first side wall portion.

10. The article supply device according to claim 9, wherein
the second side wall portion is made of a light-transmissive material.

11. The article supply device according to claim 1, wherein
the passage portion includes a start end portion and a terminal end portion, and
the attraction portion is provided at a position closer to the start end portion than to the terminal end portion.

12. The article supply device according to claim 11, wherein
the passage portion includes a drop portion that allows a coin to drop, and
the passage portion is configured to prevent the second-type coin attracted to the attraction portion from dropping into the drop portion.

13. The article supply device according to claim 12, wherein
the attraction portion is made of a magnet capable of attracting the second-type coin by a magnetic force.

14. The article supply device according to claim 13, wherein
the attraction portion includes at least a first attraction portion and a second attraction portion, and
the first attraction portion and the second attraction portion are provided to be spaced apart by a predetermined distance.

15. The article supply device according to claim 14, wherein
the first attraction portion and the second attraction portion are provided at positions in a coin moving direction that are offset in at least one of a front-rear direction or an up-down direction.

16. The article supply device according to claim 15, wherein
the predetermined distance is a distance less than a maximum diameter of the first-type coin or the second-type coin to be inserted.

17. The article supply device according to claim 1, wherein
the passage portion includes a drop portion that allows a coin to drop,
the passage portion includes an inclined portion that allows the first-type coin to be inserted into the insertion portion to move by its own weight, and
the drop portion is configured to allow the first-type coin having passed through the inclined portion to freely drop.

18. The article supply device according to claim 1, wherein
the passage portion includes a drop portion that allows a coin to drop,
the article supply device further comprises a holding portion capable of holding the first-type coin having dropped on the drop portion, and
the holding portion includes an inclination that allows the first-type coin having dropped on the drop portion to move by its own weight.

19. The article supply device according to claim 18, wherein
a coin insertion unit is formed to have a configuration including at least the passage portion and the holding portion.

20. The article supply device according to claim 10, wherein
the passage portion includes a start end portion and a terminal end portion, and
the attraction portion is provided at a position closer to the start end portion than to the terminal end portion.
